(19) United States
(12) Patent Application Publication
(10) Pub. No.: US 2023/0141874 A1
(43) Pub. Date: May 11, 2023

(54) Systems and Methods for Delivery of Targeted Advertisements Onboard Mobile Platforms

(71) Applicant: ViaSat, Inc., Carlsbad, CA (US)

(72) Inventors: Ultan O'Brien, Carrickmines (IE); Niall O'Sullivan, Dundrum (IE); Fergal Murray, Tomhaggard (IE)

(21) Appl. No.: 17/916,007

(22) PCT Filed: Mar. 30, 2020
(86) PCT No.: PCT/US2020/025809

§ 371 Date: Sep. 29, 2022

(51) Int. Cl. G06Q 30/0251

(52) U.S. Cl. CPC G06Q 30/0264; G06Q 30/0255; G06Q 30/0271

(57) ABSTRACT

Technology is described for providing targeted electronic advertisements on an aircraft. A server onboard the aircraft may establish a connection with a client device onboard the aircraft. The server may identify a user profile associated with a user of the client device. The user profile may include itinerary information for the user of the client device. The server may select a targeted electronic advertisement based in part on the itinerary information. The targeted electronic advertisement may be selected from a data store of electronic advertisements. The targeted electronic advertisement may be sent to the client device to be displayed using a graphical user interface on the client device.

### BACKGROUND

In-flight entertainment (IFE) and information systems may provide entertainment, moving map information, flight information, or other information to aircraft passengers during a flight. IFE systems may include centralized display monitors, seat back display monitors and/or connections for personal electronic devices via a wireless network, which may enable aircraft passengers to consume audio content, video content, moving map information, electronic games, etc. The audio content may include music, news, comedy, moving map information, flight information, travel information, etc. Such video content may include television programs, movies, live television programs (e.g., live news programs, live sporting events), cable programs, etc. Moving map information may provide real-time flight information. For example, the moving map information may provide a map that illustrates a current position and direction of the aircraft, as well as other information about the flight (e.g., altitude, airspeed, outside air temperature, distance to destination, distance from origination point, local time, etc.)

In one example, IFE systems may provide in-flight network connectivity to personal electronic devices, such as mobile phones, laptops or tablet computers. For example, IFE systems may allow aircraft passengers to consume audio content, video content, etc. using personal electronic devices. The personal electronic devices may receive the audio content, video content, etc. from a server onboard the aircraft via a wireless access point (e.g., a Wi-Fi access point) in the aircraft. Further, IFE systems may provide in-cabin internet service, which may enable aircraft passengers to perform activities, such as internet browsing, media viewing, texting, messaging, emailing, etc. using personal electronic devices. In-flight internet service may be provided through a satellite network in communication with communications hardware on the aircraft that enables aircraft passengers to connect to the internet from personal electronic devices via the wireless access point.

### SUMMARY

A method for providing targeted electronic advertisements on an aircraft is provided. The method may include establishing, at a server onboard the aircraft, a connection with a client device onboard the aircraft. A user profile associated with a user of the client device may be identified at the server. The user profile may include itinerary information for the user of the client device. The method may further include selecting a targeted electronic advertisement based in part on the itinerary information at the server. The targeted electronic advertisement may be selected from a data store of electronic advertisements. The targeted electronic advertisement may be sent to the client device to be displayed using a graphical user interface on the client device.

A non-transitory machine readable storage medium having instructions embodied thereon is provided. The instructions when executed by one or more processors, cause the one or more processors to perform a process. The process may include establishing, at a server onboard an aircraft, a connection with a client device onboard the aircraft. The process may include receiving a request for primary content from the client device at the server. The primary content may be stored on a data store with primary content onboard the aircraft. A user profile associated with a user of the client device may be identified at the server. The user profile may include demographic information, itinerary information and interest information. The process may include selecting a targeted electronic advertisement based in part on the user profile at the server. The targeted electronic advertisement may be selected from a data store of electronic advertisements. The primary content and the targeted electronic advertisement may be transmitted to the client device to be displayed using a graphical user interface on the client device.

A system is provided that may include at least one processor. The system may include at least one memory device including a data store to store a plurality of data and instructions. The plurality of data and instructions, when executed, cause the system to establish a connection with a client device onboard an aircraft. A user profile associated with a user of the client device may be retrieved. The user profile may include demographic information and itinerary information. A targeted electronic advertisement may be identified from a data store of electronic advertisements that corresponds with the user profile using a machine learning model. The plurality of data and instructions, when executed, cause the system to transmit the targeted electronic advertisement to the client device to be displayed using a graphical user interface on the client device.

### BRIEF DESCRIPTION OF THE DRAWINGS

FIG. 1A is a block diagram illustrating a system for providing targeted electronic advertisements on an aircraft according to an example of the present technology.

FIG. 1B is a block diagram illustrating another system for providing targeted electronic advertisements on an aircraft according to an example of the present technology.

FIG. 1C is a block diagram illustrating a system and related operations for providing targeted electronic advertisements received from a service provider environment to a client device on an aircraft according to an example of the present technology.

FIG. 2 is a block diagram illustrating a networked system for providing targeted electronic advertisements on an aircraft according to an example of the present technology.

FIG. 3 illustrates a system for updating content stored on a server of an aircraft according to an example of the present technology.

FIG. 4 illustrates a user interface that displays a home screen with targeted electronic advertisement(s) according to an example of the present technology.

FIG. 5 illustrates a user interface that displays flight information with targeted electronic advertisement(s) according to an example of the present technology.

FIG. 6 illustrates a user interface that displays shopping information with targeted electronic advertisement(s) according to an example of the present technology.

FIG. 7 illustrates a user interface that displays menu information with targeted electronic advertisement(s) according to an example of the present technology.

FIG. 8 illustrates a user interface that displays destination information with targeted electronic advertisement(s) according to an example of the present technology.

FIG. 9 illustrates a user interface that displays a public safety announcement with targeted electronic advertisement(s) according to an example of the present technology.

FIG. 10 is a flowchart of an example method for providing targeted electronic advertisements on an aircraft.

FIG. 11 is a flowchart of another example method for providing targeted electronic advertisements on an aircraft.

FIG. 12 illustrates a satellite communication system according to an example of the present technology.

FIG. 13 is a block diagram that provides an example illustration of a computing device that may be employed in the present technology.

### DETAILED DESCRIPTION

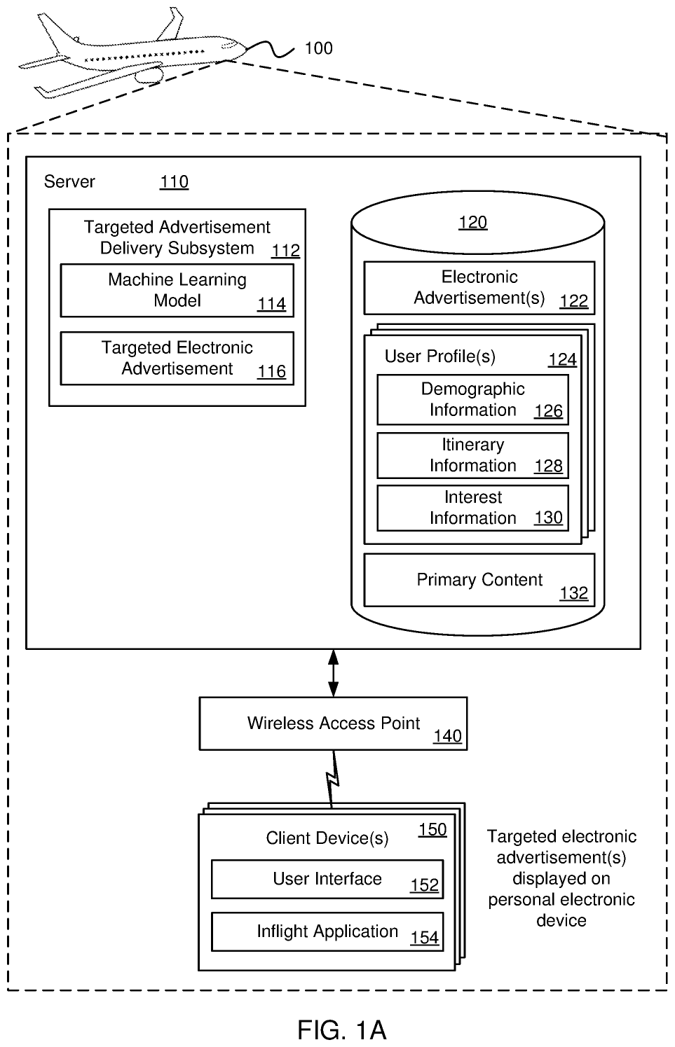

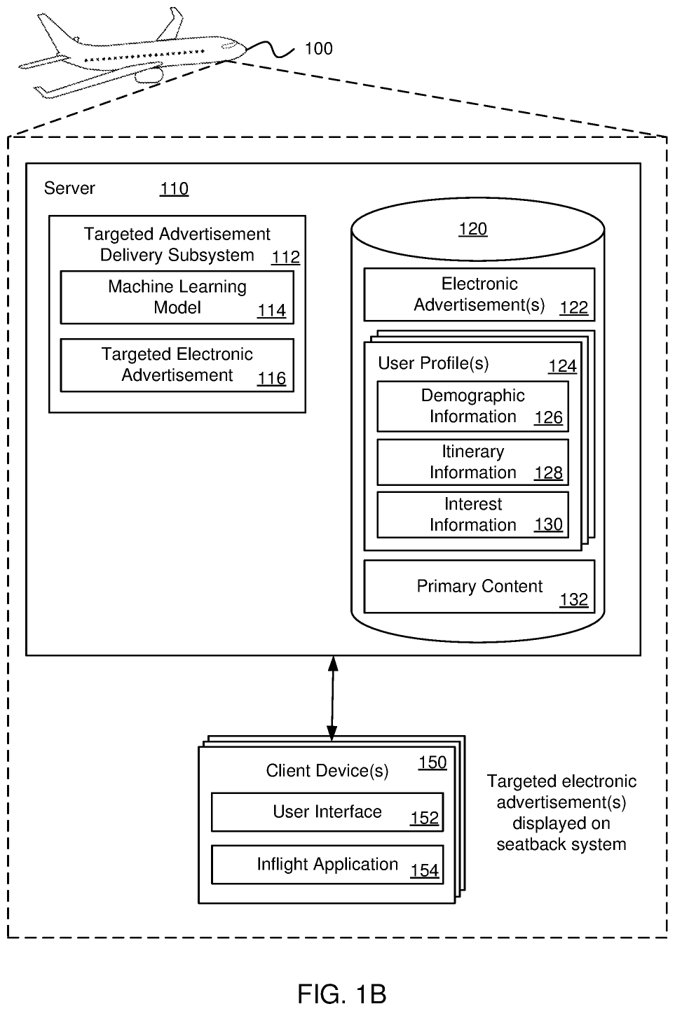

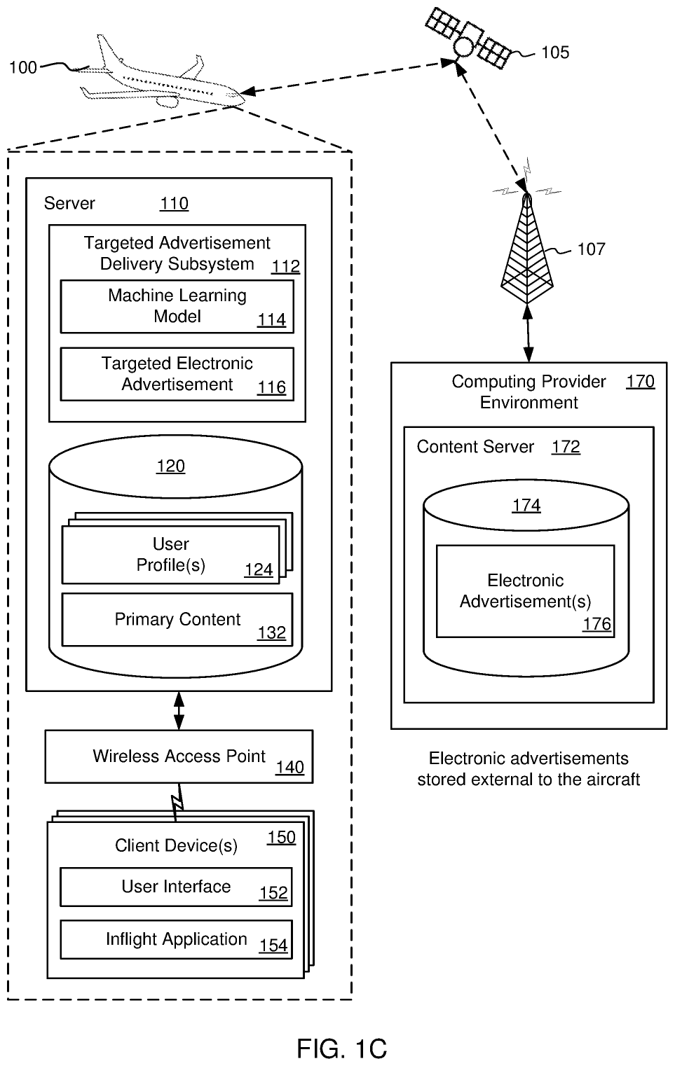

FIG. 1A illustrates an example of a system for providing targeted electronic advertisements 116 to a client device 150 on an aircraft 100. For example, the aircraft 100 may be one of multiple aircraft which are included in a fleet of aircraft. In examples described herein, the techniques described herein are described in the context of an aircraft. Alternatively, the techniques described herein for providing targeted electronic advertisements 116 may be provided to a client device 150 on another type of mobile platform, such as a ship, bus, train, etc. A server 110 onboard the aircraft 100 may select targeted electronic advertisements 116 from a data store 120 of electronic advertisements 122 based on a user profile 124, where the data store 120 may locally store the electronic advertisements 116 onboard the aircraft 100. The targeted electronic advertisements 116 may be related to products, services, offers, promotions, coupons, etc. The targeted electronic advertisements 116 are digital electronic advertisements that may be composed of digital video, digital audio, digital text, digital animation, etc. The electronic advertisements 116 may be banner advertisements, rich media advertisements, pop-up advertisements, floating advertisements, wallpaper advertisements, video advertisements, expanding advertisements, etc. Each targeted electronic advertisement 116 may be associated with one or more target characteristics (e.g., metadata, keywords, etc) stored in the data store 120 that indicate the information of the user profile that the targeted electronic advertisement 116 is tailored for. For example, if the targeted electronic advertisement 116 is targeted to a specific gender, its associated target characteristics may indicate that the specified gender. As another example, if the targeted electronic advertisement 116 is targeted to users having a destination in a particular location (e.g., city, etc.), its associated target characteristic may indicate the particular destination. The server 110 may then select the targeted electronic advertisements 116 from the data store 120 of electronic advertisements 122 by matching some or all of the information of the user profile 124 with some or all of the target characteristics. This may be done by comparing the information of the user profile 124 with the target characteristics of the targeted electronic advertisements 122, and based on the comparison selecting electronic advertisements 122 that are targeted to the user of the client device 150. The server 110 may transmit the targeted electronic advertisements 116 to client device(s) 150 via a wireless access point 140, where the client device(s) 150 and the wireless access point 140 may be onboard the aircraft 100. The client device(s) 150 may receive the targeted electronic advertisements 116 for display along with primary content 132 that can be provided for consumption to a user (e.g., a passenger) of the client device 150. Primary content 132 may for example be stored onboard the aircraft 100, such as on the server 110, and/or on another server onboard the aircraft 100. Examples of primary content 132 that may be stored onboard include data such as media content (e.g., music, videos, etc.), shopping information, moving map information, destination information, public safety announcements, etc. As yet another example, primary content 132 may additionally or alternatively be received via a wireless communication link from a remote server off-board the aircraft 100. Examples of primary content that may be received via the wireless communication link include network data accessible via a network (e.g., the Internet) such as web browsing, text messaging, email messaging, and media content (e.g., music, videos, TV channels, etc.) that may be requested by the user.

In this example, the client device 150 may be a personal electronic device, such as a mobile phone, a tablet computer, a laptop computer, etc. The client device 150 may display the targeted electronic advertisement 116 via a user interface 152. The user interface 152 may for example be associated with an application 154 (e.g., an IFE application) that executes on the client device 150. As another example, the user interface 152 may be provided when a browser is opened using the client device 150. For example, the targeted electronic advertisement 116 may be displayed with primary content 132 via the user interface 152, or the targeted electronic advertisement 116 may be displayed before or after the primary content 132 via the user interface 152.

In one example, the server 110 may establish a connection with a client device 150 via the wireless access point 140. The client device 150 may be carried by a user (e.g., a passenger) within the aircraft 100. In some examples, the user may provide login information (e.g., user credentials, such as a user name and password) via the user interface 152 to establish the connection with the server 110. In other example, the connection between the client device 150 and the server 110 may be established once the client device 150 connects to the wireless access point 140. The user interface 152 may enable the user to request and consume primary content 132, such as movies, television programs, music, electronic games, moving map information, shopping content, destination content, etc. In one example, the client device 150 may connect with the server 110 when the aircraft 100 is on the ground or after the aircraft 100 reaches a certain altitude (e.g., 10,000 feet).

In some examples, the server 110 (or another server onboard or offboard the aircraft 100) may store data associating the user profile 124 with a particular user of the client device 150. In other words, the user profile 124 may be associated with the user (or passenger) that uses the client device 150. In this example, an association may be made between the user profile 124 and a particular user from potentially multiple users of the client device 150. More specifically, the user profile 124 may be at a user level, and separate user profiles 124 may exist for separate users of the same client device 150. In such a case, multiple users may use the same client device 150, and each user may be associated with a unique user profile 124. The particular user of the client device 150 may for example be determined based on information provided by the user, such as login information, selection of a particular profile displayed within the user interface 152, other information about the user provided by the client device 150, etc.

In some examples, the user profile 124 may be linked to a client device 150, and the same user profile 124 may be used for all users of the client device 150. In other words, the user profile 124 may be set at a device level, and the same user profile 124 may be used for all users of the client device 150. Thus, in this example data can be stored on the server 110 (or another server onboard or offboard the aircraft) indicating an association between the user profile 124 and unique identifying information (e.g., MAC address) of the client device 150.

In some examples, the user profile 124 may be associated with multiple client devices 150. For example, a specific user with a specific user profile 124 may use multiple client devices 150, such as a mobile phone and a laptop computer. In this example, the same user profile 124 may be associated with each of the multiple client devices 150.

The user profile 124 may include itinerary information 128. In some examples, the itinerary information 128 of the user profile 124 may include aircraft information which may be received from aircraft computing systems over an aircraft data bus that the server 110 is in communication with. The aircraft data bus may for example operate according a protocol such as an ARINC (Aeronautical Radio, INC.) avionics protocol that may be used by the server 110 to read and record various status or operational events associated with the aircraft 100. The type of aircraft information included in the user profile 124 can vary from example to examples. Examples of aircraft information can include one or more of a current location of the aircraft, a current route (source and/or destination) of the aircraft, etc. The current route of the aircraft 100 may be a route between an aircraft origin and an aircraft destination. In some examples the user profile 124 may not include user-specific profile information. In other words, the itinerary information 128 of the user profile 124 may only contain aircraft information in such examples. In such a case, all users onboard the aircraft 100 may have the same user profile 124.

The user profile 124 may be locally stored in the data store 120 of the server 110. Alternatively, the user profile 124 may be stored on a server external (or off board) to the aircraft 100. The user profile 124 may include demographic information 126, and/or itinerary information 128 and/or interest information 130 for the user. The demographic information 126 may include one or more of user demographic data such as an age or age range, gender, languages spoken, socioeconomic status, education level, marital status, occupation, etc. associated with the user. The itinerary information 128 may aircraft information as mentioned above. The itinerary information may also or alternatively include details on the user's itinerary that is specific to that user. For example, the itinerary information 128 may include user origin information (e.g., a geographic location at which the user began travel), user destination information (e.g., a geographic location to which the user is traveling), user dates of travel, a user ticket purchase class (e.g., first class, business class, economy class), a duration of the travel, a purpose of the travel (e.g., business or leisure), a seat location, a time of travel, an amount of time between when a flight was booked and an actual flight time, etc. The interest information 130 may include one or more preferences such as certain products that are of interest to the user (e.g., televisions, skis, and sports cars), activities that are of interest to the user (e.g., football, skiing, mountain climbing, yoga), certain foods that are of interest to the user (e.g., steak, ramen), etc. In other words, the interest information 130 may describe a behavioral attribute of the user (e.g., a propensity to consume certain types of content or perform certain types of activities).

In one example, a user origin and a user destination may be associated with a user, whereas the aircraft origin and the aircraft destination may be associated with the aircraft 100 and not the user itself. Thus, the user destination and the aircraft destination may be different when the user's travel involves more than one flight. In some cases, when the user is taking multiple flights to reach the user destination, the targeted electronic advertisements 116 selected by the targeted advertisement delivery subsystem 112 (discussed in more detail below) may be based on the user destination and not an aircraft destination of an aircraft 100 on which the user is currently on.

In one example, the server 110 may create the user profile 124 based in part on information received from the user via the user interface 152 of the client device 150. For example, the user interface 152 may display a questionnaire that collects the demographic information 126, itinerary information 128 and/or interest information 130 from the user. The user may manually enter details about themselves (e.g., demographic information, likes and dislikes), and a travel itinerary. Based on this received information, the server 110 may create the user profile 124 for the user associated with the client device 150.

Additionally or alternatively, the server 110 may create the user profile 124 based in part on information received from an aircraft operator (e.g., from an airline data store) or other entity. For example, the aircraft operator may provide certain details about the user, such as the demographic information 126, itinerary information 128 and/or interest information 130. In one example, the user may be part of a loyalty program run by the aircraft operator, and as part of the loyalty program, certain details about the user may be collected over time. The server 110 may receive this information from an external server and data store associated with the aircraft operator (not shown). The server 110 may receive the information prior to takeoff of the aircraft 100, or alternatively, when the aircraft 100 is in the air. Based on this received information, the server 110 may create the user profile 124 for the user associated with the client device 150.

In one configuration, a targeted advertisement delivery subsystem 112 of the server 110 may select a targeted electronic advertisement 116 from the data store 120 of electronic advertisements 122 based on the user profile 124 of the user of the client device 150. In other words, using some or all of the demographic information 126, and/or some or all of the itinerary information 128 and/or some or all of the interest information 130 for the user represented by the user profile 124, the targeted advertisement delivery subsystem 112 may select a suitable targeted electronic advertisement 116 for delivery to the client device 150.

In one example, the targeted advertisement delivery subsystem 112 may use a machine learning model 114 to select the targeted electronic advertisement 116 based on the demographic information 126, and/or itinerary information 128 and/or interest information 130 for the user included in the user profile 124. In other words, the demographic information 126, and/or itinerary information 128 and/or interest information 130 may be inputs to the previously trained machine learning model 114, and the machine learning model 114 may produce an output that indicates that the targeted electronic advertisement 116 to be selected.

As an example, the machine learning model 114 may be generated using supervised learning, unsupervised learning or reinforcement learning. The machine learning model 114 may apply feature learning, sparse dictionary learning, anomaly detection, decision trees, association rules, heuristic rules, etc. to improve a performance of the machine learning model 114 over time. In addition, the machine learning model 114 may incorporate statistical models (e.g., regression), principal component analysis, neural networks, or any other type of artificial intelligence (AI).

As a non-limiting example, the user profile 124 for a specific user may indicate that the user is a male in his early 50s flying to New York City, makes a level of income that classifies the user as upper middle class and is flying in first class. The user profile 124 containing this information may be provided to the machine learning model 114. Based on this information, the targeted advertisement delivery subsystem 112 may select targeted electronic advertisement(s) 116 for the user, such as advertisement(s) 116 for fine wines, expensive watch stores in New York City, luxury cruise vacations, etc. based on the information about the user included in the user profile 124.

As another non-limiting example, the user profile 124 for a specific user may indicate that the user is a female in her mid-20s traveling to Thailand for three months, has an advanced graduate degree but makes a relatively low amount of income per year, and likes to read historical biography books. Based on this information, the targeted advertisement delivery subsystem 112 may select targeted electronic advertisement(s) 116 for the user, such as advertisement(s) for low-cost activities or events (e.g., visiting museums) in Thailand, highly rated hostels in Thailand, promotional bus fares or taxi fares when traveling within Thailand, etc.

As yet another non-limiting example, the user profile 124 for a specific user may indicate that the user is a male in his early 20s who is traveling to Amsterdam with friends for a summer vacation. Based on this information, the targeted advertisement delivery subsystem 112 may select targeted electronic advertisement(s) 116 for the user, such as advertisement(s) for certain events in Amsterdam (e.g., sporting events that are occurring at a time during which the user is in Amsterdam) and/or certain restaurants in Amsterdam that cater to a young population.

As a further non-limiting example, the user profile 124 for a specific user may indicate that the user is speaks Chinese and is traveling to China. Based on this information, the targeted advertisement delivery subsystem 112 may select targeted electronic advertisement(s) 116 for the user, such as advertisement(s) that are in Mandarin.

In one configuration, the server 110 may transmit the selected targeted electronic advertisement 116 to the client device 150 via the wireless access point 140. The inflight application 154 executing on the client device 150 may display the targeted electronic advertisement 116 via the user interface 152. The targeted electronic advertisement 116 may be displayed with (or before or after) the primary content 132 via the user interface 152 in a variety of manners or arrangements. For example, the targeted electronic advertisement 116 (e.g., a video advertisement for a new type of shampoo) may be displayed prior to a start of video content or audio content, or the targeted electronic advertisement 116 (e.g., an image advertisement for men's clothing) may be displayed when video content or audio content is paused. In another example, the targeted electronic advertisement 116 may be displayed along with shopping information, moving map information, destination information, etc. In yet another example, the targeted electronic advertisement 116 may be displayed when a home screen is launched on the inflight application 154.

In the past, electronic advertising on aircrafts were static and not targeted. In other words, in the past, electronic advertising did not account for information related to a user such as demographic information, a user's travel itinerary, aircraft information, user's interests, etc. The same electronic advertisements have previously been shown to all of the users on the aircraft, regardless of a user's specific personal characteristics, a user's travel itinerary, aircraft information, a user's interests, etc. As a result, in the past, users (which include passengers) were often exposed to electronic advertisements that were unrelated to the user's age, occupation, travel itinerary, interests, etc. These poorly-suited electronic advertisements could cause users to lose interest in the electronic advertisement altogether and/or skip the electronic advertisement if possible.

In the present technology, users on an aircraft may receive targeted electronic advertisements that are specific to the user such as specific to their demographic, a user's travel itinerary, interests, aircraft information, etc. The targeted electronic advertisements may be determined dynamically by the targeted advertisement delivery subsystem 112 and may be personalized for an individual user or group of users. The targeted electronic advertisements may be of increased usefulness and interest to the users, as the targeted electronic advertisements may be related to the user's destination (or other itinerary information). Based on the targeted electronic advertisements, the user may be informed of certain activities, places, restaurants, shops, etc. in the destination to which the user is traveling. Further, the targeted electronic advertisements may enhance an experience of the user on the aircraft, as the user may be exposed to more useful and informative information.

FIG. 1B illustrates an example of a system and related operations for providing targeted electronic advertisements 116 to a client device 150 on an aircraft 100. In this example, the client device 150 may be a seatback system installed on a seat in front of a user sitting in the aircraft 100. A server 110 onboard the aircraft 100 may transmit the targeted electronic advertisements 116 over a wired connection (or a wireless connection) between the server 110 and the client device 150 (e.g., the seatback system). In this example, since the client device 150 is non-stationary, the user may sit behind the seat on which the client device 150 is installed to view primary content 132 and the targeted electronic advertisements 116.

FIG. 1C illustrates an example of a system for providing targeted electronic advertisement(s) 116 received from a computing provider environment 170 to a client device 150 on an aircraft 100. The computing provider environment 170 may include a public cloud environment, a private cloud environment, a data center, centralized hardware servers, a data warehouse, etc., and the computing provider environment 170 may be external to the aircraft 100. In this configuration, a content server 172 in the computing provider environment 170 may include a data store 174 of targeted electronic advertisements 176 and associated target characteristics. More specifically, the data store 174 of electronic advertisements 176 may not be onboard the aircraft 100.

A server 110 onboard the aircraft 100 may select a targeted electronic advertisement 116 based on a user profile 124, and the server 110 may request the targeted electronic advertisement 116 from the content server 172 in the computing provider environment 170. The server 110 may request the targeted electronic advertisement 116 when the aircraft 100 is in the air. The server 110 on the aircraft 100 may communicate with the content server 172 in the computing provider environment 170 via a satellite 105 and a ground station 107. For example, communications from the server 110 may go to the satellite 105 and then to the content server 172 via the ground station 107, and vice versa. The content server 172 in the computing provider environment 170 may respond with the requested targeted electronic advertisement 116, and the server 110 onboard the aircraft 100 may send the targeted electronic advertisement 116 to the client device 150. In this configuration, the electronic advertisements 176 are not stored locally on the aircraft 100, but rather in the computing provider environment 170.

In one example, the server 110 may select the targeted electronic advertisement 116 from an off-board advertisement exchange platform that operates in the computing provider environment 170. Therefore, in this example, the targeted electronic advertisement 116 may be transmitted from the off-board advertisement exchange platform to the server 110 onboard the aircraft 100, and the targeted electronic advertisement 116 may be forwarded to the client device 150. Alternatively, the targeted electronic advertisement 116 may be transmitted from the off-board advertisement exchange platform to the client device 150 while bypassing the server 110.

In one example configuration, the targeted advertisement delivery subsystem 112 may be a service that operates in the computing provider environment 170. In other words, rather than operating on the server 110 onboard the aircraft 100, the targeted advertisement delivery subsystem 112 may be a service that operates in the computing provider environment 170 that is external to the aircraft 100.

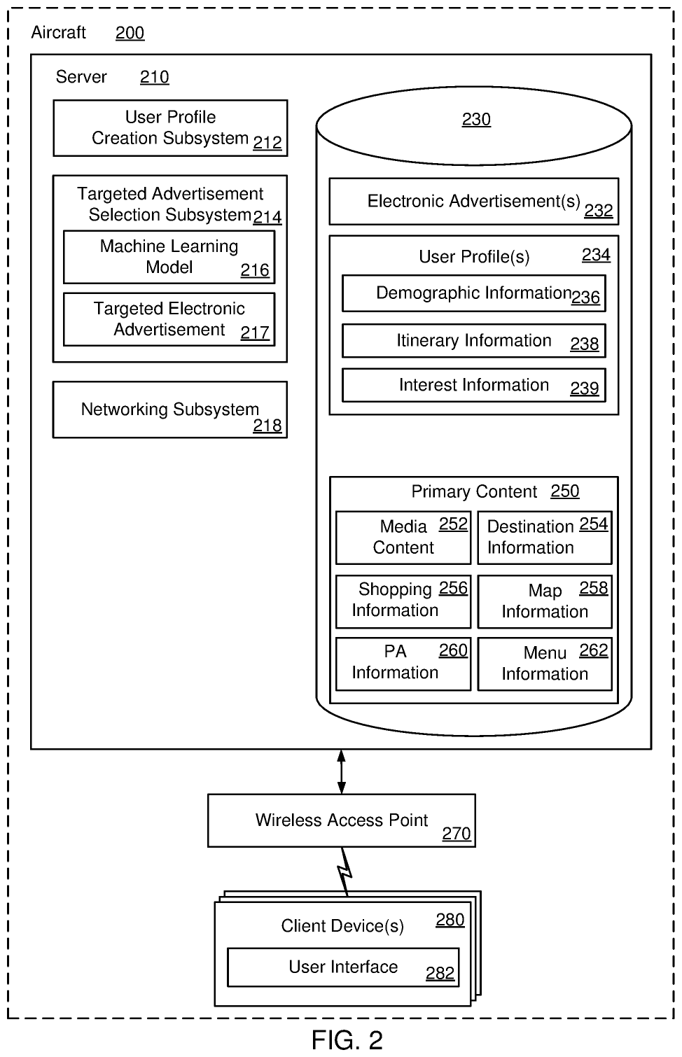

FIG. 2 illustrates example components of the present technology in a server 210. The server 210 may be operable to select targeted electronic advertisement(s) 217 from a data store 230 of electronic advertisements 232 based on user profile(s) 234, and transmit the targeted electronic advertisement(s) 217 to client device(s) 280 via a wireless access point 270 (or over a wired connection). The server 210, the data store 230, the wireless access point 270 and the client device(s) 280 may be included within or onboard an aircraft 200. Alternatively, the server 210, the data store 230, the wireless access point 270 and the client device(s) 280 may be included within or onboard another type of vehicle, such as a ship, bus, train, etc. In addition, the user profile(s) 234 may be locally stored on the data store 230 of the server 210 included in the aircraft 200.

In one example, the server 210 may include the data store 230 that includes the electronic advertisement(s) 232. The electronic advertisements 232 may be digital electronic advertisements that are composed of digital video, digital audio, digital text, digital animation, etc. The electronic advertisements 232 may be banner advertisements, rich media advertisements, pop-up advertisements, floating advertisements, wallpaper advertisements, video advertisements, or expanding advertisements. The electronic advertisements 232 may be for products, services, offers, promotions, coupons, etc. The electronic advertisements 232 may relate to a wide variety of population demographics and geographical locations. The electronic advertisements 232 may be displayed on electronic pages provided to the client devices 280.

In one example, the electronic advertisements 232 may each include or otherwise be associated with one or more target characteristics (e.g., metadata, key words, etc.) that describe the nature of the electronic advertisement 232. As a non-limiting example, a certain electronic advertisement 232 may be associated with metadata that indicates this advertisement is related to a type of sunglasses and is applicable to men of ages 20-35. As another non-limiting example, a certain electronic advertisement 232 may be associated with metadata that indicates this advertisement is related to an amusement park in California and is applicable to families with young children.

The data store 230 may include user profile(s) 234. A user profile 234 associated with a certain user (e.g., passenger) may include demographic information 236, and/or itinerary information 238 and/or interest information 239. The user profile(s) 234 may be for user(s) of the client device(s) 280 included in the aircraft 200. For example, one user profile 234 may be associated with one user that uses the client device 280 on the aircraft 200. In other words, the user profile 234 may be at a user level, and separate user profiles 234 may exist for separate users of the same client device 280. Alternatively, one user profile 234 may be associated with the client device 280 and the hardware ID of the client device (e.g., a MAC (media access control) address). More specifically, the user profile 234 may be linked to device, and a same user profile 234 may be used for all users of the client device 280.

In one example, the demographic information 236 may include, but is not limited to, an age, gender, languages spoken, socioeconomic status, education level, marital status, occupation, etc. associated with the user.

In one example, the itinerary information 238 may include, but is not limited to, user origin information (e.g., a geographic location at which the user began travel), user destination information (e.g., a geographic location to which the user is traveling), dates of travel, a ticket purchase class (e.g., first class, business class, economy class), a purpose of the travel (e.g., business or leisure), etc. The itinerary information 238 may indicate when the user has layovers in one or more cities, as part of the itinerary.

In one example, the interest information 239 may include, but is not limited to, certain products or services that are of interest to the user (e.g., boots, motorcycles, gardening equipment), activities that are of interest to the user (e.g., basketball, theater), etc. The interest information 239 may include one or more behavioral attributes of the user, such as a propensity to purchase certain products, interests related to searches, previously consumed media content by the user, etc. The interest information 239 may provide behavior attributes that are beyond transactional information for the user.

The itinerary information may include aircraft information. The aircraft information may include details about the aircraft 200 received from aircraft computing systems via an aircraft data bus on the aircraft 200. The aircraft data bus is the connectors or set of wires that provide transportation for avionics data within an aircraft. Generally speaking, information obtained from the aircraft data bus is information that is specific to the aircraft 200. The aircraft data bus may use serial data transfer to minimize a size and weight of aircraft cabling. Thus, various systems on the aircraft 200 may communicate information, such as the aircraft information, to each other using the aircraft data bus.

The aircraft information may include a type of aircraft 200 or features of the aircraft 200. In addition, the aircraft information may include aircraft origin information and/or aircraft destination information for the current route of the aircraft 200. In some cases, the destination of the aircraft 200 may be a layover for a particular user and not a final destination for that user, whereas in other cases, the destination of the aircraft 200 may be a particular user's final destination. Further, the aircraft information may include an estimated arrival time, an arrival gate, a current latitude and longitude of the aircraft and/or an aircraft speed.

The data store 230 may include primary content 250, such as media content 252, destination information 254, shopping information 256, map information 258, public announcement (PA) information 260 (or public safety information), menu information 262, etc. The media content 252 may include movies, television shows, cartoons, music, audio books, etc. that are consumable by the user(s).

The destination information 254 may include information on a plurality of destinations that is viewable to the user(s). For example, for a given destination, the destination information 254 may describe historical information, neighborhood information, transportation information, sightseeing information, activity information, hotel information, restaurant information, emergency contact information, etc. The shopping information 256 may include a listing of products that are available for purchase to the user(s). The products may span a variety of categories, such as electronics, apparel, books, household items, beauty products, etc.

The map information 258 may include moving map information of the aircraft's current position and trajectory, as projected onto a visual map that is viewable to the user(s). The map information 258 may also include information about altitude, airspeed, outside air temperature, distance to destination, distance from origination point, local time, etc. The PA information 260 may include an infomercial about safety procedures that is viewable to the user(s). For example, the PA information 260 may be viewed by the user(s) prior to takeoff of the aircraft 200. In addition, the menu information 262 may be an electronic menu that indicates foods, drinks, personal items, etc. that are complimentary on the aircraft 200 or available for purchase to the user(s).

The server 210 may utilize a number of subsystems for providing targeted electronic advertisements on the aircraft 200. For example, the server 210 may operate a user profile creation subsystem 212, a targeted advertisement selection subsystem 214, networking subsystem 218, and other applications, services, processes, modules, systems, subsystems, engines, or functionality not discussed in detail herein.

The user profile creation subsystem 212 may create a user profile 234 for a user (or a passenger) on the aircraft 200. The user profile creation subsystem 212 may create the user profile 234 based on input (e.g., user profile information) received from the client device 280. For example, the user profile creation subsystem 212 may receive the demographic information 236, itinerary information 238 and/or interest information 239 from the client device 280, and use this information to create the user profile 234.

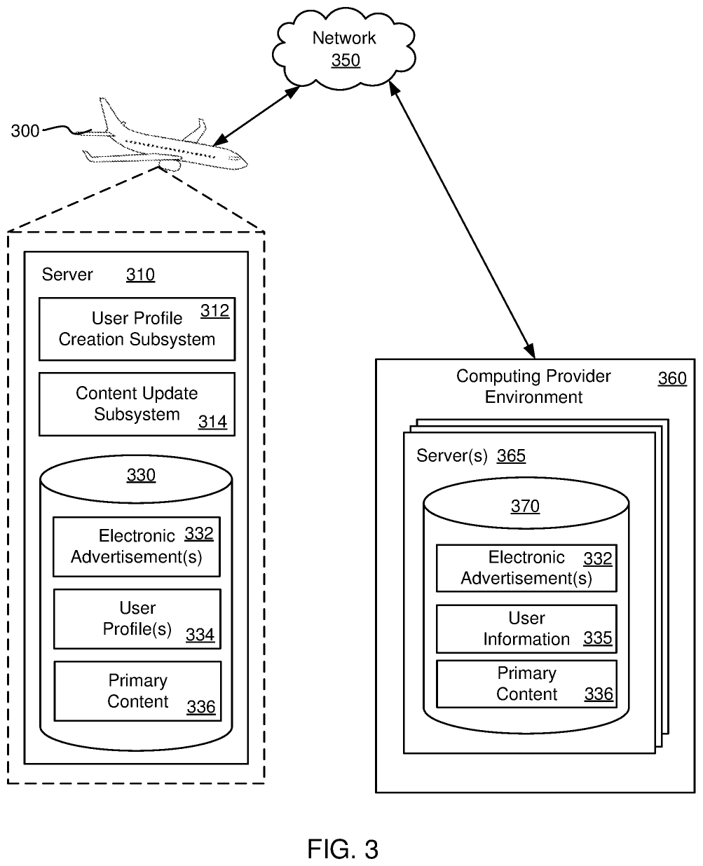

In one example, the user may provide the user profile information during a flight via a user interface 282 on the client device 280. The user interface 282 may prompt the user to provide the user profile information using a series of questions, checkboxes, forms, etc. Additionally or alternatively, the user profile 234 may be created using user profile information received from a data store of user information associated with an aircraft operator (e.g., as shown in FIG. 3) or other entity. The user profile information may be stored at an off-board location and may be received prior to take-off of the aircraft 200. In both cases, the user profile information may be locally stored on a data store of user profiles onboard the aircraft 200, and the user profile information may be used to create the user profile 234. Further, the user profile 234 may be created and updated based on previous electronic activities of the user while onboard the aircraft 200, such as movies or music consumed by the user, advertisements interacted with by the user, websites visited by the user, etc. In some examples, the user profile 234 of the user is created and updated based on previous electronic activities of the user while onboard multiple aircraft which are included in a fleet of aircraft.

The targeted advertisement selection subsystem 214 may select a targeted electronic advertisement 217 from the data store 230 of electronic advertisements 232 based on the user profile 234. The targeted advertisement selection subsystem 214 may compare information in the user profile 234 with the target characteristic(s) associated with the electronic advertisements 232 stored in the data store, and based on this comparison, the targeted advertisement selection subsystem 214 may identify targeted electronic advertisement(s) 217 that are targeted to a specific user on the aircraft 200.

In a specific example, the targeted advertisement selection subsystem 214 may use a machine learning model 216 to select the targeted electronic advertisement 217 based on the demographic information 236, itinerary information 238 and/or interest information 239 for the user associated with the user profile 234. The machine learning model 216 may receive information in the user profile 234 as input, and the machine learning model 216 may produce an output that includes a listing of targeted electronic advertisement(s) 217 that are specific to the user's profile.

In one example, the targeted advertisement selection subsystem 214 may select the targeted electronic advertisement 217 using a set of rules based on the user profile 234, and the set of rules used for selecting the targeted electronic advertisement 217 may be incorporated in the machine learning model 216. In other words, using the user profile 234 as input or features, the targeted advertisement selection subsystem 214 may use the machine learning model 216 to select the targeted electronic advertisement 217.

In one configuration, the targeted advertisement selection subsystem 214 may select targeted electronic advertisement(s) 217 based on the aircraft information of the user profiles 234. For example, the targeted advertisement selection subsystem 214 may select targeted electronic advertisement(s) 217 from the data store 230 that are related to the destination of the aircraft 200, as indicated in the aircraft information. Further, the targeted advertisement selection subsystem 214 may identify users on the aircraft 200 whose final destination is the same as the destination of the aircraft 200, as indicated in the itinerary information 238 in the user profiles 234. The targeted advertisement selection subsystem 214 may target these users to receive the targeted electronic advertisement(s) 217 related to the destination.

As a non-limiting example, the aircraft information may indicate that the aircraft 200 is currently flying to the city of Houston. In this example, the targeted advertisement selection subsystem 214 may select targeted electronic advertisement(s) 217 from the data store 230 that are related to the city of Houston. For example, the targeted advertisement selection subsystem 214 may select targeted electronic advertisement(s) 217 that are related to an upcoming oil and gas conference in Houston, activities to do in Houston, restaurants in Houston, etc. In addition, the targeted advertisement selection subsystem 214 may identify users on the aircraft 200 whose final destination is Houston, as indicated in their respective user profile(s) 234. The targeted advertisement selection subsystem 214 may target the users whose final destination is Houston to receive the targeted electronic advertisement(s) 217 related to the city of Houston. Furthermore, the targeted advertisement selection subsystem 214 may further filter the targeted electronic advertisement(s) 217 based on the demographic information 236 and/or interest information 239 of the users whose final destination is Houston.

The networking subsystem 218 may transmit the targeted electronic advertisement(s) 217 using a network connection (e.g., using a network socket) to enable delivery of the targeted electronic advertisement(s) 217 to the client device 280 via the wireless access point 270. The targeted electronic advertisement(s) 217 may be displayed via the user interface 282 of the client device 280. In one example, the targeted electronic advertisement(s) 217 may be displayed along with the primary content 250.

The client device(s) 280 may comprise, for example, processor-based systems. The client device(s) 280 may be personal electronic devices, such as laptops or notebook computers, tablet computers, mobile devices, handheld computers, smart watches, or other devices with like capability. Alternatively, the client device(s) 280 may be seatback computing systems with displays that are installed on seats of the aircraft 200. For example, a user may view content displayed on a seatback system that is installed on a seat in front of the user.

The various processes and/or other functionality contained within the server(s) 210 (and other servers described herein) may be executed on one or more processors that are in communication with one or more memory modules. The server(s) 210 (and other servers described herein) may include a number of computing devices that are arranged, for example, in one or more server banks or computer banks or other arrangements.

The term “data store” may refer to any device or combination of devices capable of storing, accessing, organizing and/or retrieving data, which may include any combination and number of data servers, relational databases, NoSQL databases, object oriented databases, cluster storage systems, data storage devices, data warehouses, flat files and data storage configuration in any centralized, distributed, or clustered environment. The storage system components of the data store may include storage systems such as a SAN (Storage Area Network), cloud storage network, volatile or non-volatile RAM, optical media, or hard-drive type media. The data store may be representative of a plurality of data stores as can be appreciated.

In one configuration, the server 210 may communicate with the client device(s) 280 via a network. The network may include any useful computing network, including a localized network, a wireless data network, Wi-Fi network, BLUETOOTH, ZIGBEE, or any other such network or combination thereof. Components utilized for such a system may depend at least in part upon the type of network and/or environment selected. Communication over the network may be enabled by wired or wireless connections and combinations thereof.

FIG. 2 illustrates that certain processing modules or subsystems may be discussed in connection with this technology. In one example configuration, a module or subsystem may be considered a service with one or more processes executing on a server or other computer hardware. For example, modules or subsystems providing services may be considered on-demand computing that are hosted in a server. An application programming interface (API) may be provided for each module or subsystem to enable a second module or subsystem to send requests to and receive output from a first module or subsystem. Such APIs may also allow third parties to interface with the module or subsystem and make requests and receive output from the modules or subsystems.

While FIG. 2 illustrates an example of a system that may implement the techniques above, many other similar or different environments are possible. The example environments discussed and illustrated above are merely representative and not limiting.

FIG. 3 illustrates an exemplary system for creating user profile(s) 334, and updating electronic advertisement(s) 332 and primary content 336 stored on a server 310 of an aircraft 300. The electronic advertisement(s) 332, user profile(s) 334 and primary content 336 may be locally stored on a data store 330 of the server 310. Alternatively, the server 310 may be included on another type of vehicle, such as a ship, bus, train, etc. In one example, the aircraft 300 may be grounded and able to connect to a computing provider environment 360 via a network 350 in order to create the user profile(s) 334 and update the electronic advertisement(s) 332 and primary content 336. For example, the network 350 may be a wide area network that is capable of handling increased data speeds for transferring relatively large amounts of data (e.g., the primary content 336) that are stored on the aircraft in preparation for flight. Alternatively, the aircraft 300 may be in the air and connect to the computing provider environment 360 (e.g., the network 350 may be a satellite communication network) in order to create the user profile(s) 334 and update the electronic advertisement(s) 332 and primary content 336.

In one example, the computing provider environment 360 may include server(s) 365 and data store(s) 370. The server(s) 365 may be associated with advertisement providers, aircraft operators, media content providers, etc. The data store(s) 370 may include a plurality of electronic advertisements 332. The electronic advertisements 332 may be related to a wide variety of products, services, promotions, offers, coupons, etc. for a number of destinations, personal preferences, aircraft characteristics, demographics, etc. The data store(s) 370 may include user information 335. For example, the user information 335 may be associated with a customer loyalty program run by an airline operator. The data store(s) 370 may include primary content 336, such as media content, shopping information, destination information, etc.

In one configuration, the server 310 of the aircraft 300 may include a user profile creation subsystem 312 operable to create the user profile(s) 334. The user profile creation subsystem 312 may receive the user information 335 from the server(s) 365 in the computing provider environment 360 via the network 350, and the user information 335 may be used to create the user profile(s) 334 for local storage on the data store 330 of the aircraft 300. For example, the user profile creation subsystem 312 may receive the user information 335 from the server 365 when the aircraft 300 is grounded, due to increased costs associated with receiving data when the aircraft 300 is in the air. Based on the user information 335 received from the server 365, the user profile creation subsystem 312 may create and store the user profile(s) 334 in the data store 330 of the aircraft 300.

In one example, the server 310 of the aircraft 300 may include a content update subsystem 314 to update the electronic advertisement(s) 332 and primary content 336 stored on the server 310 of the aircraft 300. The content update subsystem 314 may receive electronic advertisements 332 and primary content 336 from the server(s) 365 in the computing provider environment 360 via the network 350, and the content update subsystem 314 may update the electronic advertisements 332 and the primary content 336 currently stored on the data store 330 of the aircraft 300 with the information received from the server 365 in the computing provider environment 360. The content update subsystem 314 may receive the up-to-date electronic advertisements 332, user profiles 334, and primary content 336 from the server(s) 365 when the aircraft 300 is grounded (or while in the air). The content update subsystem 314 may periodically update the electronic advertisements 332 to include new products that are available for sale, new activities or promotions that are available, etc. Similarly, the content update subsystem 314 may periodically update the primary content 336 to include new movies, television programs, etc.

In one example, a targeted electronic advertisement may be an opening overlay banner or video that is provided via a user interface on startup, such as after a user initially launches the user interface. The opening overlay banner or video may range for example from 30 seconds to 3 minutes, and a user may be required to view the advertisement or a user may have skip through options. In addition, the opening overlay banner or video may include a link to certain channels or aggregations of content access through user interface buttons or tabs, such as a content channel (e.g., for video content, game content, music content, etc.) or an electronic commerce (e-commerce) channel such as microsite or website.

In one example, a targeted electronic advertisement may be a logo overlay on a home carousel of primary content 336 that is provided via a user interface using user interface buttons or tabs to switch between application options, presentation screens or channels. The home carousel can be a revolving presentation of services available onboard. The home carousel may refer to a home screen that enables a user to access media content, shopping, map information, etc. The logo overlay may be an advertisement that is presented over the content of the carousel and that continues to be displayed as the carousel moves. Further, the logo overlay may include links to various channels, such as an activation channel, which may enable passengers to engage with digital content.

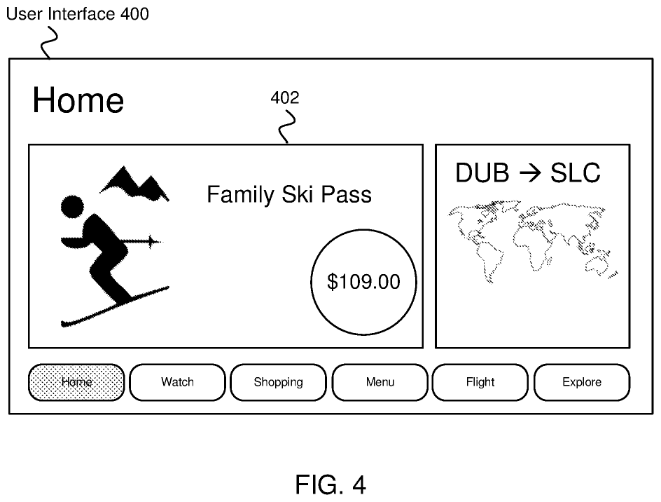

FIG. 4 is an example of a user interface 400 that displays a home screen or homepage with targeted electronic advertisement(s) 402. The home screen may initially be displayed when an inflight application is launched on a client device, or when a user opens a web browser on the client device. The home screen may also be displayed when a user exits a particular window (e.g., ends a movie or television program). The targeted electronic advertisement(s) 402 may be displayed along with flight information, and the targeted electronic advertisement(s) 402 may be specific to a user profile associated with the client device. The targeted electronic advertisement(s) 402 may be related to demographic information, and/or itinerary information, and/or interest information. In one example, the targeted electronic advertisement 402 may be displayed along with a welcome message, where the welcome message may provide a link to various channels, such as an activation channel (e.g., a microsite, a website, etc.) associated with the targeted electronic advertisement. The activation channel can allow the user to further engage in content associated with the targeted electronic advertisement, such as purchasing a product and/or signing up for a service.

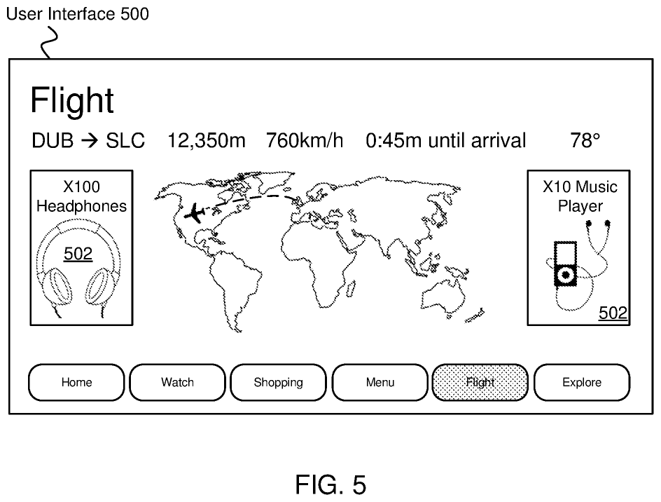

FIG. 5 is an example of a user interface 500 provided by the server that displays flight information (e.g., a moving map) with targeted electronic advertisement(s) 502. The flight information may be displayed via an inflight application executing on a client device, via a web browser on the client device, etc. The flight information may include origin information, destination information, altitude information, speed information, time until arrival, current temperature at the destination, etc. The targeted electronic advertisement(s) 502 may be displayed alongside the flight information. In other words, when a user selects an option to view the flight information, the inflight application may also display the targeted electronic advertisement(s) 502. In one example, the targeted electronic advertisement 502 may be a banner associated with a moving map channel that promotes a specific offer, and may include a link to various channels, such as an engagement or ecommerce channel. In another example, the targeted electronic advertisements 502 may be a banners for the moving map channel that includes multiple feature tiles, such as three separate tiles that each display a separate banner for the moving map channel In some examples, the targeted electronic advertisements 502 may be targeted and different each time (i.e., dynamic) the user returns to the user interface 500 of flight information.

In one example, an entertainment channel provided by the server may be accessed by a user via a user interface to watch television shows, movies, etc. A banner or overlay window that is a targeted electronic advertisement may be provided on entertainment channel (or other available entertainment channels) via the user interface that may or may not be related to the content on the entertainment channel. In a second example, the targeted electronic advertisement may be a pre-roll video that the user is required to view before watching their selected primary content. The pre-roll video may for example be a trailer for other movies or television content that is provided via the entertainment channel Alternatively, the pre-roll video may not be related to the content provided via the entertainment channel. In another example, the targeted electronic advertisement may be an interstitial banner or inter-roll banner (e.g., interstitial or inter-roll) on the entertainment channel. In yet another example, the targeted electronic advertisement may be a pause overlay advertisement that is provided via the entertainment channel The pause overlay advertisement may be a video or other type of advertisement that is provided once the content of the entertainment channel is paused by the user. In such a case, the server may receive an indication that the user has paused the content of the entertainment channel (e.g. by the user providing input via the user interface). In response to receiving the indication, the server may select a targeted electronic advertisement for the user using the techniques described herein and provide the targeted electronic advertisement for overlay on the entertainment channel within the user interface. In some examples, the user is required to close the pause overlay advertisement (e.g., by the user providing input via the user interface) before the server resumes the content of the entertainment channel In some examples in which the pause overlay advertisement is a video, the user is required to view the video before the server resumes the content of the entertainment channel.

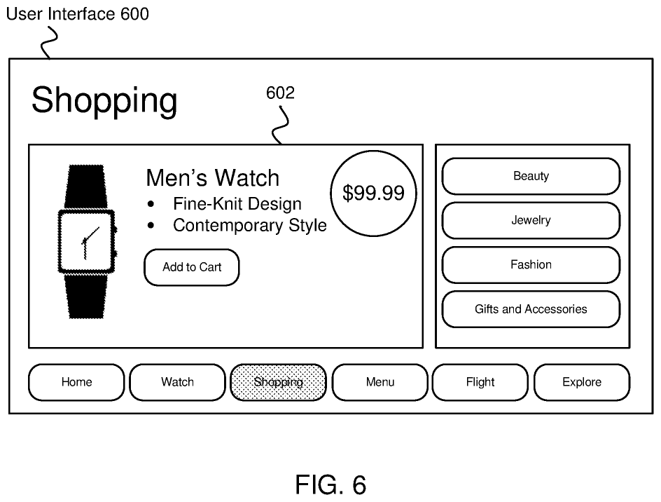

FIG. 6 is an example of a user interface 600 that displays shopping information from the server with targeted electronic advertisement(s) 602. The shopping information may be displayed through a shopping channel via an inflight application executing on a client device, or via a web browser on the client device. The shopping information may include a number of product categories, such as beauty, jewelry, fashion, gifts and accessories, etc. A user may browse through the product categories to view products that are available for purchase. The targeted electronic advertisement(s) 602 may be displayed alongside the shopping information. In other words, when the user selects an option to view the shopping information, the inflight application may also display the targeted electronic advertisement(s).

In one example, the targeted electronic advertisement 602 may be a feature banner, pop-up window, overlay window, audio player, or video that is displayed on a main carousel of the shopping channel. For example, the main carousel may provide options to view shopping categories, such as beauty products, jewelry products, etc. Alternatively, the targeted electronic advertisement 602 may be a feature banner or video that is displayed on a sub-category carousel of the shopping channel. For example, the sub-category carousel may display products that correspond to a certain sub-category, such as beauty, jewelry, fashion, gifts and accessories, lifestyle, travel items, technology gadgets, etc.

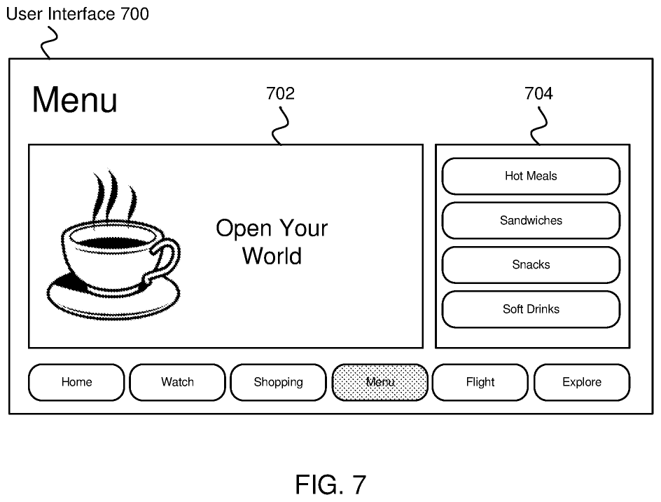

FIG. 7 is an example of a user interface 700 that displays menu information with targeted electronic advertisement(s) 702. The menu information may be displayed via an inflight application executing on a client device, or via a web browser on the client device. The menu information may include food items and/or drink items that are available on an aircraft. The food items and/or drink items may be complimentary items, or alternatively, may be available for purchase. The targeted electronic advertisement(s) 702 may be displayed alongside the menu information. In other words, when the user selects an option to view the menu information, the inflight application may also display the targeted electronic advertisement(s) 702.

In one example, the targeted electronic advertisement 702 may be a feature banner or video that is displayed on a main carousel of a bistro menu. For example, the main carousel may provide options to view hot meals, sandwiches, snacks, soft drinks, etc., 704. Alternatively, the targeted electronic advertisement 702 may be a feature banner or video that is displayed on a sub-category carousel or sub-menu of the bistro menu. For example, the sub-category carousel may display products (e.g., candy) that correspond to a certain sub-category, such as snacks.

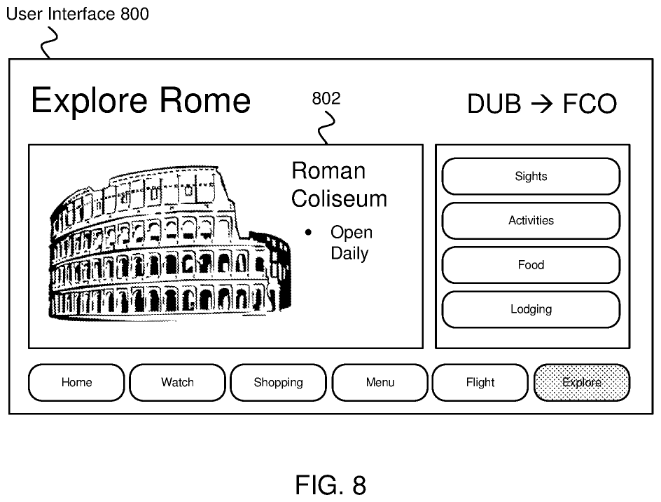

FIG. 8 is an example of a user interface 800 that displays destination information from the server with targeted electronic advertisement(s) 802. The destination information may be displayed through a destination channel via an inflight application executing on a client device, or via a web browser on the client device. The destination information may include information on a destination that is viewable to a user. With respect to a selected destination, the destination information may include historical information, neighborhood information, transportation information, sightseeing information, activity information, hotel information, restaurant information, emergency contact information, etc. The targeted electronic advertisement(s) 802 may be displayed alongside the destination information. In other words, when the user selects an option to view the destination information, the inflight application may also display the targeted electronic advertisement(s) 802 on any topic or goods and services selected for a user profile on the client device.

In one example, the targeted electronic advertisement 802 may be a feature video or pre-roll video regarding a particular destination and may be provided via the destination channel. In another example, the targeted electronic advertisement 802 may be an interstitial banner or inter-roll banner for destination content that is provided via the destination channel.

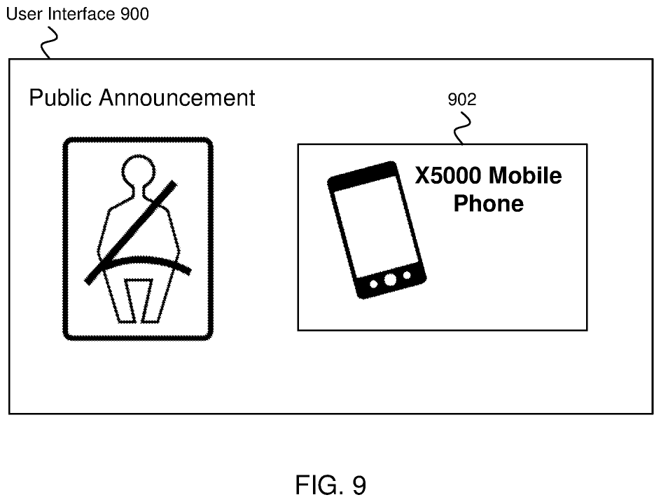

FIG. 9 is an example of a user interface 900 that displays a public announcement from the server with targeted electronic advertisement(s) 902. The public announcement may be an initial service announcement, a turbulence or pilot announcement, a flight attendant announcement, a pre-landing announcement, etc. The public announcement may be a video announcement that is played at a start of a flight or during the flight. The public announcement may be displayed via an inflight application executing on a client device, or via a web browser on the client device. In one example, the public announcement may be automatically played, and a user may not select playback of the public safety announcement. The server may receive an indication that the public announcement has begun based on aircraft information received via the aircraft data bus system on the aircraft. Alternatively, the server may receive the indication in a different way. In response to receiving the indication, the server may suspend the primary content (if any) that is currently displayed in the user interface, and select a targeted electronic advertisement for the user. The targeted electronic advertisement(s) 902 may be displayed before, during or after the public announcement. For example, prior to the public announcement, after playback of the public announcement or during the public announcement, the targeted electronic advertisement(s) 902 may be displayed to the user. In examples in which the targeted electronic advertisement 902 is displayed during the public announcement, the server may continue displaying the targeted electronic advertisement until receiving an indication that the public announcement has been completed (e.g., based on aircraft information received via the aircraft data bus system). In such a case, upon receiving the indication, the server may then resume the primary content (if any) that is currently displayed in the user interface. In examples in which the targeted electronic advertisement 902 is displayed after the public announcement, the server may wait until receiving the indication that the public announcement has been completed. In such a case, upon receiving the indication, the server may provide the targeted electronic advertisement 902 for display in the user interface. In one example, the targeted electronic advertisement 902 may be a post-roll video, which follows the public announcement.

In one example, the home screen or home carousel, the flight information and the moving map, the shopping information, the menu information, the destination information, and the public announcement, as described in FIGS. 4-9, may be transmitted from a server onboard an aircraft to a client device. Data associated with the home screen, the flight information and the moving map, the shopping information, the menu information, the destination information and/or the public safety announcement may be locally stored on the aircraft, or alternatively, may be stored on a service provider environment (e.g., public cloud or private servers) that is external to the aircraft. In this alternative example, the data may be sent from the service provider environment to a server or networking device on the aircraft, and then to the client device onboard the aircraft.

In one example, engagement analytics may be tracked for the targeted electronic advertisements that are provided along with the home screen, the flight information and moving map, the shopping information, the menu information, the destination information, the public announcement, etc. The engagement analytics may indicate a total number of impressions or views for a specific targeted electronic advertisement, a total number or rate of user interactions for a specific targeted electronic advertisement, a click through rate, an amount of time spent viewing or interacting with a specific targeted electronic advertisement, a total amount of revenue collected with respect to a specific targeted electronic advertisement, etc. The engagement analytics may be collected on an individual user level or another higher more aggregated level (e.g. for a group of passengers on a plane or for a specific flight origin and destination pairing). For example, the engagement analytics may indicate, for a particular user, a number of times that the user selected a targeted electronic advertisement, an amount of time spent interacting with a targeted electronic advertisement, etc.

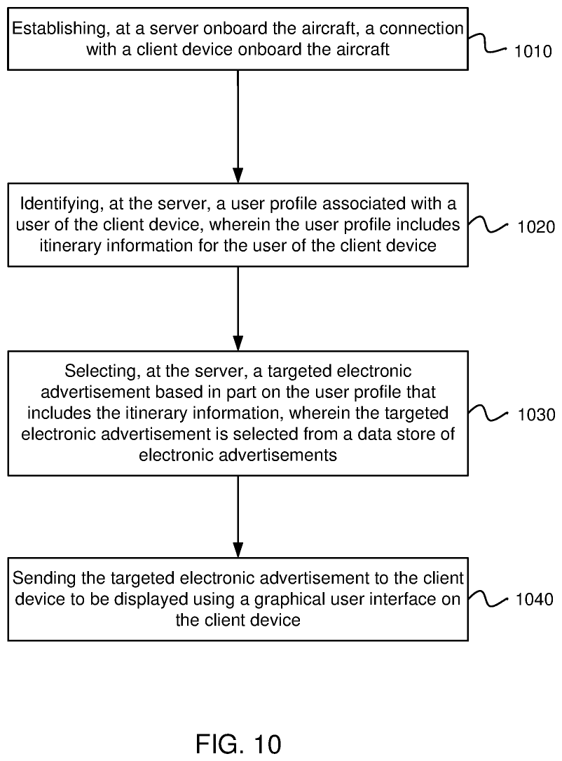

FIG. 10 illustrates an example of a method for providing targeted electronic advertisements on an aircraft. The targeted electronic advertisements may be for a product, a service, an offer, a promotion and/or a coupon. A server onboard the aircraft may establish a connection with a client device onboard the aircraft, as in block 1010. In one example, the connection between the server and the client device may be a wireless connection established via a wireless access point onboard the aircraft, and the client device may be a personal electronic device. In another example, the client device may be a seatback system on the aircraft, and the connection between the server and the seatback system may be a wired connection.

The server may identify a user profile associated with a user of the client device, as in block 1020. The user profile may include itinerary information for the user of the client device. The itinerary information for the user of the client device may include a travel origin, a travel destination, dates of travel, a ticket purchase class, a seat location, a time of travel, a day of the week of travel, a total duration of a trip, a ticket price, and/or a time between a flight booking time and an actual flight time. In one example, the user profile associated with the user may further include demographic information of the user. In another example, the user profile associated with the user may further include interest information of the user, where the interest information may include a behavioral attribute of the user.

The server may select a targeted electronic advertisement based in part on the user profile that includes the itinerary information, the demographic information and/or the interest information, as in block 1030. For example, the targeted electronic advertisement may be selected using a machine learning model. The user profile may be input into the machine learning model, and an output of the machine learning model may indicate the targeted electronic advertisement to be selected.

In another example, the targeted electronic advertisement may be selected based on aircraft information received via an aircraft data bus system on the aircraft. The aircraft information may include an aircraft origin, an aircraft destination, an estimated arrival time, an arrival gate, a current latitude and longitude of the aircraft, and/or an aircraft speed.

In one example, the targeted electronic advertisement may be selected from a data store of electronic advertisements. In one example, the data store of electronic advertisements may be located onboard the aircraft. Alternatively, the data store of electronic advertisements may be located in a service provider environment that is external to the aircraft.

The targeted electronic advertisement may be sent to the client device to be displayed using a graphical user interface on the client device, as in block 1040. In one example, the targeted electronic advertisement may be transmitted to the client device along with media content, shopping information, moving map information, or destination information.

In one configuration, user profile information may be obtained from the client device via the graphical user interface on the client device, where the graphical user interface may prompt the user to provide the user profile information. Further, user profile information may be obtained from a data store of user information associated with an aircraft operator prior to take off of the aircraft. The user profile information received from the client device and/or the data store of user information may be used to create the user profile for the user of the client device. Further, the user profile may be created based on previous activities of the user while onboard the aircraft.

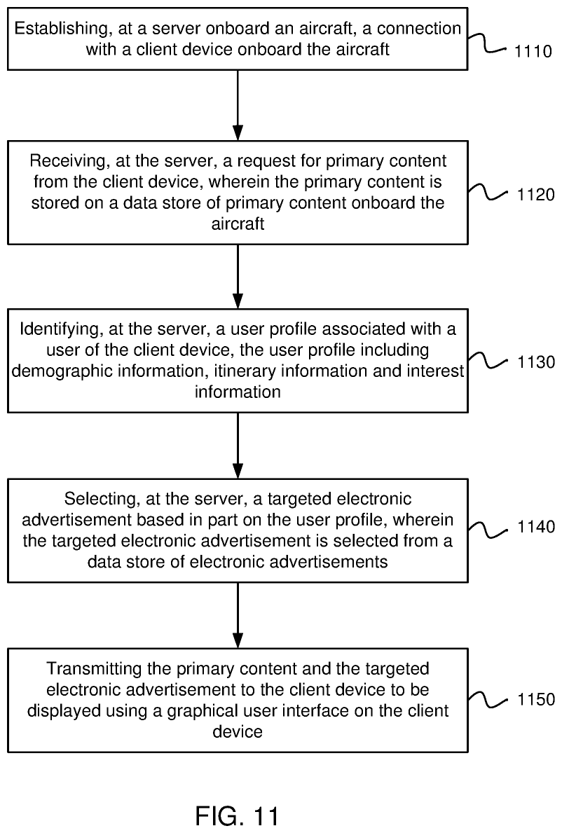

FIG. 11 illustrates an example of a method for providing targeted electronic advertisements on an aircraft. A server onboard the aircraft may establish a connection with a client device onboard the aircraft, as in block 1110. The connection between the server and the client device may be a wireless connection established via a wireless access point onboard the aircraft.

The server may receive a request for primary content from the client device, as in block 1120. The primary content may include media content, shopping information, moving map information, or destination information. The primary content may be stored on a data store of primary content onboard the aircraft.

The server may identify a user profile associated with a user of the client device, as in block 1130. The user profile may include demographic information for the user, itinerary information that describes a travel of the user, and/or interest information that describes a behavioral attribute or an interest of the user.

The server may select a targeted electronic advertisement based in part on the user profile, as in block 1140. For example, the targeted electronic advertisement may be selected using a machine learning model. Further, the targeted electronic advertisement may be selected from a data store of electronic advertisements.

The primary content and the targeted electronic advertisement may be transmitted to the client device to be displayed using a graphical user interface on the client device, as in block 1150. Therefore, the targeted electronic advertisement may be displayed on the graphical user interface with the media content, shopping information, moving map information, or destination information.

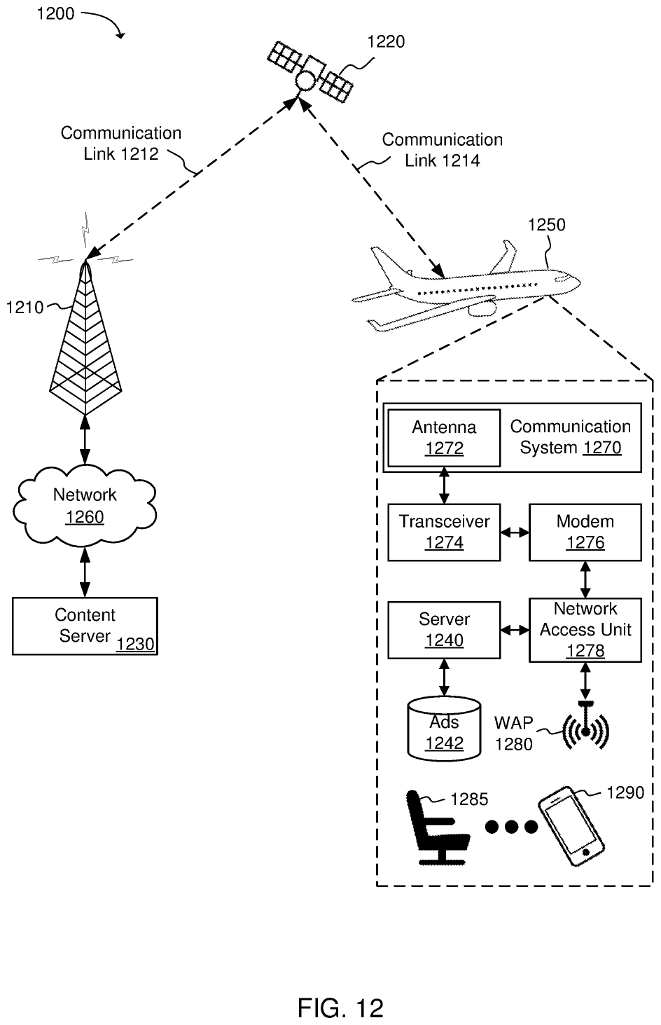

FIG. 12 illustrates an example of a satellite communication system 1200. The satellite communication system 1200 may include satellite(s) 1220 in bidirectional communication with a ground station 1210 via a communication link 1212 between the satellite 1220 and the ground station 1210. The satellite 1220 may also be in bidirectional communication with an aircraft 1250 (e.g., an airplane, helicopter, blimp or balloon) via a communication link 1214 between the satellite 1220 and the aircraft 1250. The communication link 1212 and the communication link 1214 may enable communication between the aircraft 1250 and the ground station 1210 via the satellite 1220 while the aircraft 1250 is stationary or in motion.

In one example, the satellite communication system 1200 may include multiple satellites 1220, where each satellite 1220 may provide coverage for a service area, and service areas for different satellites may be non-overlapping or overlapping. The satellite communication system 1200 may be any suitable type of satellite system, including a geostationary satellite system, medium earth orbit satellite system, low earth orbit satellite system, or combinations thereof. The satellite 1220 may have a number of beams directed at different regions on Earth, where the coverage area of each beam may be non-overlapping or overlapping with one or more other beams. The satellite 1220 may have one or more spot beams covering different regions on Earth within the service area of the satellite 1220. As another example, the satellite 1220 may have one or more wide area coverage beams covering the service area of the satellite 1220. As yet another example, the satellite 1220 may have a combination of spot beams and wide area coverage beams.

In one configuration, the aircraft 1250 may include a communication system 1270 to facilitate bidirectional communication with the satellite 1220 via the communication link 1214. The communication system 1270 may include an antenna 1272 to receive a downlink signal from the satellite 1220 and transmit an uplink signal to the satellite 1220 via the communication link 1214. The aircraft 1250 may include a transceiver 1274 in communication with the antenna 1272, a modem 1276 in communication with the transceiver 1274, a network access unit 1278 (e.g., a router) in communication with the modem 1276, and a wireless access point (WAP) 1280 in communication with the network access unit 1278. Further, the wireless access point 1280 may communicate with one or more client devices in the aircraft 1250, such as seatback systems 1285 and/or personal electronic devices 1290 (e.g., mobile phones, tablets, laptops) in the aircraft 1250. Therefore, the communication system 1270 may receive a downlink signal from the satellite 1220 and forward the downlink signal to the client devices, and receive an uplink signal from the client devices and forward the uplink signal to the satellite 1220, thereby supporting two-way data communications between the client devices within the aircraft 1250 and the satellite 1220.

In one configuration, the network access unit 1278 may be in communication with a server 1240 onboard the aircraft 1250. The server 1240 may identify a user profile associated with a user of the seatback system 1285 or the personal electronic device 1290, where the user profile may include itinerary information for the user. The server 1240 may select a targeted electronic advertisement based in part on the user profile, where the targeted electronic advertisement may be selected from a data store of electronic advertisements 1242. The targeted electronic advertisement may be sent to the client devices, such as the seatback system 1285 or the personal electronic device 1290, for display on an interface.

In one example, the seatback system 1285 may be a fixed or on-aircraft device. The seatback system 1285 may communicate with the server 1240 via a wired communication link. For example, the seatback system 1285 may communicate with the network access unit 1278 over a wired communication link, and the network access unit 1278 may communicate with the server 1240 over a wired communication link. Alternatively, the seatback system 1285 may communicate with the server 1240 via the network access unit 1278 and the wireless access point 1280. The seatback system 1285 may execute one or more applications that provide an interface for users on the aircraft 1250 to obtain and consume data.

In one example, the personal electronic device 1290 may receive and display data, and may be brought onto the aircraft 1250 by users (which include passengers or crew members). The personal electronic devices 1290 may execute one or more applications that provide the interface for users to obtain and consume data. The user may have the option to select/request data for viewing from the interface. When a user interacts with the personal electronic device 1290, the personal electronic device 1290 may transmit a request for data to the network access unit 1278 via the wireless access point 1280. The personal electronic device 1290 may receive requested data from the network access unit 1278 via the wireless access point 1280. Thus, the wireless access point 1280 may provide communication between the network access unit 1278 and personal electronic device 1290.

In one example, the network access unit 1278 may receive requests for data from the personal electronic device 1290 via the wireless access point 1280 and forward the requests to the modem 1276. The network access unit 1278 may receive packets associated with the data, and forward the data to the personal electronic device 1290 via the wireless access point 1280.

In one example, the modem 1276 may receive requests for data from the network access unit 1278, and the modem 1276 may generate modulated data (e.g., a transmit intermediate frequency (IF) signal) for delivery to the transceiver 1274. Further, the modem 1276 may receive requested data as a modulated data (e.g., a receive intermediate frequency (IF) signal) from the transceiver 1274 and demodulate that data for transmission to the network access unit 1278. In one example, the modem 1276 may be integrated with the network access unit 1278, or alternatively, the modem 1276 and the network access unit 1278 may be separate components.

In one example, the transceiver 1274 may up-convert and amplify modulated data received from the modem 1276 to generate an uplink signal for transmission to the satellite 1220 via the antenna 1272. Similarly, the transceiver 1274 may receive a downlink signal from the satellite 1220 via the antenna 1272. The transceiver 1274 may then amplify and down-convert the downlink signal to generate modulated downlink data for demodulation by the modem 1276.

In one example, the ground station 1210 may also be referred to as an access node, a hub or a gateway. The ground station 1210 may include an antenna to transmit an uplink signal to the satellite 1220 and receive a downlink signal from the satellite 1220. The ground station 1210 may be in communication with a content server 1230 via a network 1260. The content server 1230 may include electronic advertisements, media content, web content, etc.

In one example, the network 1260 may be any type of network and may be for example, an internet, an internet protocol (IP) network, an intranet, a wide area network (WAN), local area network (LAN), a virtual private network (VPN), a virtual LAN (VLAN), a fiber optic network, a cable network, a public switched telephone network (PSTN), a public switched data network (PSDN), a public land mobile network, a cellular network, and/or any other type of network supporting communication as described herein. The network 1260 may include both wired and wireless connections as well as optical links.

In one example, the ground station 1210 may be provided as an interface between the network 1260 and the satellite 1220. The ground station 1210 may receive data and information directed to the seatback system 1285 and/or the personal electronic device 1290 onboard the aircraft 1250 from the content server 1230 accessible via the network 1260. The ground station 1210 may format the data and information and transmit an uplink signal to the satellite 1220 for subsequent delivery to the aircraft 1250 (and then the seatback system 1285 and/or the personal electronic device 1290). Similarly, the ground station 1210 may receive a downlink signal from the satellite 1220 (e.g., containing data and information originating from the seatback system 1285 and/or the personal electronic device 1290 on the aircraft 1250) that is directed to a destination accessible via the network 1260. The ground station 1210 may format the received downlink signal for transmission on the network 1260.

In one configuration, the seatback system 1285 and/or the personal electronic device 1290 may be onboard the aircraft 1250. Alternatively, the seatback system 1285 and/or the personal electronic device 1290 may be onboard other types of vehicles, such as trains, automobiles (e.g., cars, trucks, busses, etc.), watercraft (e.g., private boats, commercial shipping vessels, cruise ships, etc.) and others.

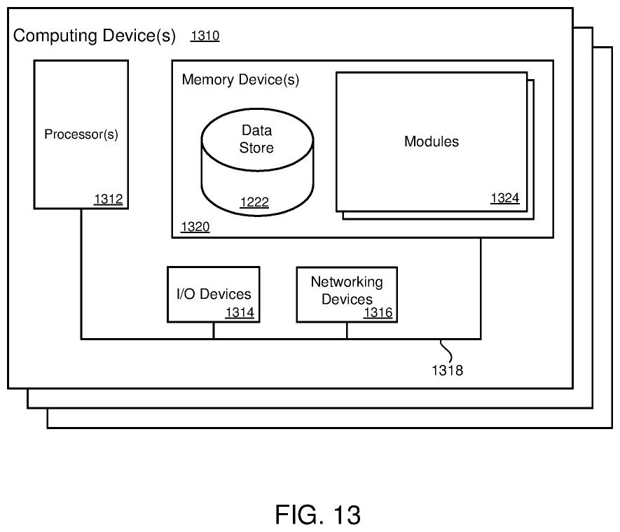

FIG. 13 illustrates a computing device 1310 on which modules of this technology may execute. The computing device 1310 is illustrated on which a high level example of the technology may be executed. The computing device 1310 may include one or more processors 1312 that are in communication with memory devices 1320. The computing device may include a local communication interface 1318 for the components in the computing device. For example, the local communication interface may be a local data bus and/or any related address or control busses as may be desired.

The memory device 1320 may contain modules 1324 that are executable by the processor(s) 1312 and data for the modules 1324. The modules 1324 may execute the functions described earlier. A data store 1322 may also be located in the memory device 1320 for storing data related to the modules 1324 and other applications along with an operating system that is executable by the processor(s) 1312.

Other applications may also be stored in the memory device 1320 and may be executable by the processor(s) 1312. Components or modules discussed in this description that may be implemented in the form of software using high programming level languages that are compiled, interpreted or executed using a hybrid of the methods.

The computing device may also have access to I/O (input/output) devices 1314 that are usable by the computing devices. An example of an I/O device is a display screen that is available to display output from the computing devices. Other known I/O device may be used with the computing device as desired. Networking devices 1316 and similar communication devices may be included in the computing device. The networking devices 1316 may be wired or wireless networking devices that connect to the internet, a LAN, WAN, or other computing network.

The components or modules that are shown as being stored in the memory device 1320 may be executed by the processor 1312. The term “executable” may mean a program file that is in a form that may be executed by a processor 1312. For example, a program in a higher level language may be compiled into machine code in a format that may be loaded into a random access portion of the memory device 1320 and executed by the processor 1312, or source code may be loaded by another executable program and interpreted to generate instructions in a random access portion of the memory to be executed by a processor. The executable program may be stored in any portion or component of the memory device 1320. For example, the memory device 1320 may be random access memory (RAM), read only memory (ROM), flash memory, a solid state drive, memory card, a hard drive, optical disk, floppy disk, magnetic tape, or any other memory components.

The processor 1312 may represent multiple processors and the memory 1320 may represent multiple memory units that operate in parallel to the processing circuits. This may provide parallel processing channels for the processes and data in the system. The local interface 1318 may be used as a network to facilitate communication between any of the multiple processors and multiple memories. The local interface 1318 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom Very Large Scale Integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, electrically erasable programmable read-only memory (EEPROM), flash memory or other memory technology, compact disc read-only memory (CD-ROM), digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

In describing the present technology, the following terminology will be used: The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” means quantities, dimensions, sizes, formulations, parameters, shapes and other characteristics need not be exact, but can be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations including, for example, tolerances, measurement error, measurement accuracy limitations and other factors known to those of skill in the art, can occur in amounts that do not preclude the effect the characteristic was intended to provide. Numerical data can be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited.

As an illustration, a numerical range of “about 1 to 5” should be interpreted to include not only the explicitly recited values of about 1 to about 5, but also include individual values and sub-ranges within the indicated range. Thus, included in this numerical range are individual values such as 2, 3 and 4 and sub-ranges such as 1-3, 2-4 and 3-5, etc. This same principle applies to ranges reciting only one numerical value (e.g., “greater than about 1”) and should apply regardless of the breadth of the range or the characteristics being described. A plurality of items can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Furthermore, where the terms “and” and “or” are used in conjunction with a list of items, they are to be interpreted broadly, in that any one or more of the listed items can be used alone or in combination with other listed items. The term “alternatively” refers to selection of one of two or more alternatives, and is not intended to limit the selection to only those listed alternatives or to only one of the listed alternatives at a time, unless the context clearly indicates otherwise. The term “coupled” as used herein does not require that the components be directly connected to each other. Instead, the term is intended to also include configurations with indirect connections where one or more other components can be included between coupled components. For example, such other components can include amplifiers, attenuators, isolators, directional couplers, redundancy switches, and the like. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples. As used herein, a “set” of elements is intended to mean “one or more” of those elements, except where the set is explicitly required to have more than one or explicitly permitted to be a null set.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for providing targeted electronic advertisements on an aircraft, the method comprising:
establishing, at a server onboard the aircraft, a connection with a client device onboard the aircraft;
identifying, at the server, a user profile associated with a user of the client device, wherein the user profile includes itinerary information for the user of the client device;
selecting, at the server, a targeted electronic advertisement based in part on the itinerary information of the user profile, wherein the targeted electronic advertisement is selected from a data store of electronic advertisements; and
sending the targeted electronic advertisement to the client device to be displayed using a graphical user interface on the client device.

2. The method of claim 1, further comprising transmitting the targeted electronic advertisement to the client device along with primary content.

3. The method of claim 1, wherein the user profile associated with the user further includes demographic information of the user, and selecting the targeted electronic advertisement is further based in part on the demographic information of the user.

4. The method of claim 1, wherein:
the user profile associated with the user further includes interest information of the user, wherein the interest information includes a behavioral attribute of the user; and
the selecting the targeted electronic advertisement is further based in part on the interest information including the behavioral attribute.

5. The method of claim 1, wherein the targeted electronic advertisement is selected from the data store of electronic advertisements using a machine learning model, and the user profile is input into the machine learning model, and an output of the machine learning model indicates the targeted electronic advertisement to be selected or a type of targeted electronic advertisement to be selected.

6. The method of claim 1, wherein the itinerary information includes aircraft information received via an aircraft data bus.

7. The method of claim 6, wherein the aircraft information includes at least one of: an aircraft origin, an aircraft destination, an estimated arrival time, an arrival gate, a current latitude and longitude of the aircraft, or an aircraft speed.

8. The method of claim 1, wherein the itinerary information for the user of the client device includes at least one of: a user travel origin, a user travel destination, user dates of travel, a user ticket purchase class, a user seat location, a time of travel, a day of the week of travel, a total duration of a trip, a user ticket price, or a time between a flight booking time and an actual flight time.

9. The method of claim 1, further comprising:
obtaining user profile information, in part, from the client device via the graphical user interface on the client device, wherein the graphical user interface prompts the user to provide the user profile information; and
creating the user profile based in part on the user profile information obtained from the client device.

10. The method of claim 1, further comprising:
obtaining user profile information, in part, from a data store of user information associated with an aircraft operator;
adding the user profile information to the user profile stored in a data store of user profiles on the server onboard the aircraft; and
selecting the targeted electronic advertisement based in part on the user profile information.

11. The method of claim 1, further comprising creating the user profile based in part on previous electronic activities of the user while onboard the aircraft.

12. The method of claim 11, wherein the user profile is further based on previous electronic activities of the user while onboard multiple aircraft which are included in a fleet of aircraft.

13. The method of claim 1, wherein the targeted electronic advertisement is for at least one of: a product, a service, an offer or a promotion.

14. The method of claim 1, wherein the connection between the server and the client device is a wireless connection established via a wireless access point onboard the aircraft.

15. The method of claim 1, wherein the data store of electronic advertisements is located onboard the aircraft.

16. The method of claim 1, wherein the client device is a personal electronic device.

17. The method of claim 1, wherein the client device is a seatback system on the aircraft, and the connection between the server and the seatback system is a wired or wireless connection.

18. A non-transitory machine readable storage medium having instructions embodied thereon, the instructions when executed by one or more processors, cause the one or more processors to perform a process including:
establishing, at a server onboard an aircraft, a connection with a client device onboard the aircraft;
identifying, at the server, a user profile associated with a user of the client device, wherein the user profile includes itinerary information for the user of the client device;
selecting, at the server, a targeted electronic advertisement based in part on the itinerary information of the user profile, wherein the targeted electronic advertisement is selected from a data store of electronic advertisements; and
sending the targeted electronic advertisement to the client device to be displayed using a graphical user interface on the client device.

19. The non-transitory machine readable storage medium of claim 18, wherein the targeted electronic advertisement is sent with primary content selected from a group consisting of: media content, shopping information, moving map information, or destination information.

20. The non-transitory machine readable storage medium of claim 18, wherein the user profile associated with the user further includes demographic information of the user, and selecting the targeted electronic advertisement is further based in part on the demographic information of the user.

21. The non-transitory machine readable storage medium of claim 18, wherein:
the user profile associated with the user further includes interest information of the user, wherein the interest information includes a behavioral attribute of the user; and
the selecting the targeted electronic advertisement is further based in part on the interest information including the behavioral attribute.

22. The non-transitory machine readable storage medium of claim 18, wherein the itinerary information for the user of the client device includes at least one of: user a travel origin, a user travel destination, user dates of travel, a user ticket purchase class, a user seat location, a time of travel, a day of the week of travel, a total duration of a trip, a user ticket price, or a time between a flight booking time and an actual flight time.

23. The non-transitory machine readable storage medium of claim 18, wherein the targeted electronic advertisement is selected from the data store of electronic advertisements using a machine learning model, wherein the user profile is input into the machine learning model, and an output of the machine learning model indicates the targeted electronic advertisement to be selected or a type of targeted electronic advertisement to be selected.

24. The non-transitory machine readable storage medium of claim 18, wherein the itinerary information includes aircraft information received via an aircraft data bus.

25. The non-transitory machine readable storage medium of claim 24, wherein the aircraft information includes at least one of: an aircraft origin, an aircraft destination, an estimated arrival time, an arrival gate, a current latitude and longitude of the aircraft, or an aircraft speed.

26. The non-transitory machine readable storage medium of claim 18, further comprising instructions when executed by the one or more processors, cause the one or more processors to perform the process including:
obtaining user profile information, in part, from the client device via the graphical user interface on the client device, wherein the graphical user interface prompts the user to provide user profile information; and
updating the user profile based in part on the user profile information obtained from the client device.

27. The non-transitory machine readable storage medium of claim 18, further comprising instructions when executed by the one or more processors, cause the one or more processors to perform the process including:
obtaining user profile information, in part, from a data store of user profile information associated with an aircraft operator;
adding the user profile information to the user profile stored in a data store of user profiles on the server onboard the aircraft; and
selecting the targeted electronic advertisement based in part on the user profile information.

28. The non-transitory machine readable storage medium of claim 18, further comprising instructions when executed by the one or more processors, cause the one or more processors to perform the process including: creating the user profile based in part on electronic activities of the user while onboard the aircraft.

29. The non-transitory machine readable storage medium of claim 28, wherein the user profile is further based in part on electronic activities of the user while onboard multiple aircraft which are included in a fleet of aircraft.

30. The non-transitory machine readable storage medium of claim 18, wherein the targeted electronic advertisement is for at least one of: a product, a service, an offer or a promotion.

31. The non-transitory machine readable storage medium of claim 18, wherein the connection between the server and the client device is a wireless connection established via a wireless access point onboard the aircraft.

32. The non-transitory machine readable storage medium of claim 18, wherein the data store of electronic advertisements is located onboard the aircraft.

33. The non-transitory machine readable storage medium of claim 18, wherein the client device is a personal electronic device.

34. The non-transitory machine readable storage medium of claim 18, wherein the client device is a seatback system on the aircraft, and the connection between the server and the seatback system is a wired or wireless connection.

35. A system, comprising:
at least one processor;
at least one memory device including a data store to store a plurality of data and instructions that, when executed, cause the system to:
establish a connection with a client device onboard an aircraft;
identify a user profile associated with a user of the client device, wherein the user profile includes itinerary information for the user of the client device;
select a targeted electronic advertisement based in part on the itinerary information of the user profile, wherein the targeted electronic advertisement is selected from a data store of electronic advertisements; and
send the targeted electronic advertisement to the client device to be displayed using a graphical user interface on the client device.

36. The system of claim 35, wherein the plurality of data and instructions, when executed, cause the system to: transmit the targeted electronic advertisement to the client device along with primary content.

37. The system of claim 35, wherein the plurality of data and instructions, when executed, cause the system to: create the user profile based, in part, on user profile information received from the client device and previous electronic activities of the user while onboard the aircraft.

38. The system of claim 35, wherein the user profile associated with the user further includes demographic information of the user, and identifying the targeted electronic advertisement is further based in part on the demographic information of the user.

39. The system of claim 35, wherein:
the user profile associated with the user further includes interest information of the user, wherein the interest information includes a behavioral attribute of the user; and
the targeted electronic advertisement is identified based in part on the interest information including the behavioral attribute.

40. The system of claim 35, wherein the user profile is input into the machine learning model, and an output of the machine learning model indicates the targeted electronic advertisement or a type of targeted electronic advertisement.

41. The system of claim 35, wherein the itinerary information includes aircraft information received via an aircraft data bus.

42. The system of claim 41, wherein the aircraft information includes at least one of: an aircraft origin, an aircraft destination, an estimated arrival time, an arrival gate, a current latitude and longitude of the aircraft, or an aircraft speed.

43. The system of claim 41, wherein the itinerary information for the user of the client device includes at least one of: a user travel origin, a user travel destination, user dates of travel, a user ticket purchase class, a user seat location, a time of travel, a day of the week of travel, a total duration of a trip, a user ticket price, or a time between a flight booking time and an actual flight time.

44. The system of claim 35, wherein the plurality of data and instructions, when executed, cause the system to:
obtain user profile information, in part, from a data store of user information associated with an aircraft operator;
add the user profile information to the user profile stored in a data store of user profiles on the server onboard the aircraft; and
select the targeted electronic advertisement based in part on the user profile information.

45. The system of claim 35, wherein the plurality of data and instructions, when executed, cause the system to: create the user profile based in part on electronic activities of the user while onboard the aircraft.

46. The system of claim 45, wherein the user profile is further based in part on electronic activities of the user while onboard multiple aircraft which are included in a fleet of aircraft.

47. The system of claim 35, wherein the targeted electronic advertisement is for at least one of: a product, a service, an offer or a promotion.

48. The system of claim 35, wherein the connection between the server and the client device is a wireless connection established via a wireless access point onboard the aircraft.

49. The system of claim 35, wherein the data store of electronic advertisements is located onboard the aircraft.

50. The system of claim 35, wherein the client device is a personal electronic device.

51. The system of claim 35, wherein the client device is a seatback system on the aircraft, and the connection between the server and the seatback system is a wired or wireless connection.
